(19) United States
(12) Patent Application Publication
(10) Pub. No.: US 2014/0232683 A1
(43) Pub. Date: Aug. 21, 2014

(54) DISPLAY DEVICE WITH TOUCH SENSOR, CONTROL SYSTEM AND CONTROL METHOD THEREOF

(71) Applicant: NLT Technologies, Ltd., Kanagawa (JP)

(72) Inventor: Shizuo MORISHITA, Kanagawa (JP)

(73) Assignee: NLT Technologies, Ltd., Kanagawa (JP)

(21) Appl. No.: 14/180,730

(22) Filed: Feb. 14, 2014

(30) Foreign Application Priority Data
Feb. 15, 2013 (JP) 2013-027464

(51) Int. Cl. G06F 3/044

(52) U.S. Cl. CPC G06F 3/044
USPC 345/174

(57) ABSTRACT

A display device with a touch sensor and the like, capable of adjusting the external noise even in a state where the touch sensor is being placed on a display panel or a state where the display device with the touch sensor is being mounted into an electronic apparatus, includes a display panel, a capacitance type touch sensor provided by being superimposed on the display panel, and a distance variable mechanism which changes the distance between the touch sensor and the display panel.

### CROSS-REFERENCE TO RELATED APPLICATION

This application is based upon and claims the benefit of priority from Japanese patent application No. 2013-027464, filed on Feb. 15, 2013, the disclosure of which is incorporated herein in its entirety by reference.

### BACKGROUND OF THE INVENTION

1. Field of the Invention

The present invention relates to a display device with a touch sensor, which is a display device provided with a capacitance type touch sensor, and to a control system as well as a control method thereof.

2. Description of the Related Art

The display device provided with the capacitance type touch sensor has such an issue that a lot of noises are mixed into detection signals of the touch sensor since the touch sensor placed adjacent to a display panel is influenced by the noises generated from the display panel so that the accuracy of the position detection by the touch sensor becomes deteriorated.

For that, Japanese Unexamined Patent Publication 2010-169791 “Liquid Crystal Display Device” (Patent Document 1) proposes a technique which prevents the noises from being transmitted to the touch sensor from a liquid crystal panel through providing a conductive layer between the liquid crystal panel and the touch sensor. Hereinafter, the technique depicted in Patent Document 1 will be described in details.

As shown in FIG. 17, Patent Document 1 discloses a liquid crystal display device 101, an upper transparent substrate 102, a lower transparent substrate 103, a liquid crystal layer 104, an upper transparent electrode 105, a lower electrode 106, a seal 107, a metal wiring 108, a polarization plate 109, a conductive layer 110, a conductive material 111, a touch panel 113, a liquid crystal panel 114, a side face of the liquid crystal panel 116, a display area DA, and the like. The liquid crystal display device 101 includes: the liquid crystal panel 114 having a surface including the display area DA where images are displayed and a side face for sectioning the surface; and the touch panel 113 placed on top of the surface. The conductive layer 110 is formed between the liquid crystal panel 114 and the touch panel 113, and the conductive material 111 is formed from the entire circumference of the side end part of the conductive layer 110 to the entire circumference of the side face 116 of the liquid crystal panel 114. It is intended with this structure to increase the accuracy of position detection by the touch panel 113 through preventing the malfunctions of the touch panel 113 caused by the electromagnetic waves radiated from the liquid crystal panel 114 side.

Further, Japanese Unexamined Patent Publication 2010-271925 “Display Device and Electronic Apparatus” (Patent Document 2) discloses a technique which suppresses the influence of the noise transmitted to the touch sensor from the liquid crystal panel without providing a conductive layer (shield layer) between the liquid crystal panel and the touch sensor. This technique is to conduct detection actions by correcting detection signals according to the gradation of image signals when acquiring the detection signal.

In the meantime, Japanese Unexamined Patent Publication 2011-197991 “Sensor Device and Display Device” (Patent Document 3) discloses a technique which intends to increase the accuracy of position detection through acquiring a fine capacitance change by changing the distance between the touch panel and the casing even when the change between the electrodes within the touch panel generated by pressing the touch panel is very small. Note, however, that the change in the distance between the touch panel and the casing with this technique is generated by applying a pressure on the touch panel.

However, in the state of the display device with the touch sensor in which the touch sensor and the display device are combined, there are individual differences generated in the influences of the external noises in the touch sensor due to variations in the structural members and assembling tolerance. Thus, when the display device with the touch sensor is mounted into an electronic apparatus, it is not possible with the techniques described in Patent Documents 1 to 3 to perform adjustment even when the optimum values for the external noise vary for each device since those are being mounted into the electronic apparatuses. Note that the external noise means an electric noise generated by the electronic apparatus itself to which the display device with the touch sensor is mounted in addition to an electric noise generated by the display panel.

It is therefore an exemplary object of the present invention to provide a display device with a touch sensor and the like capable of performing the adjustment for the external noise even in a state where the touch sensor is being placed on the display panel or in a state where the display device with the touch sensor is being mounted into the electronic apparatus.

### SUMMARY OF THE INVENTION

The display device with a touch sensor according to an exemplary aspect of the invention includes: a display panel; a capacitance type touch sensor which is provided by being superimposed on the display panel; and a distance variable mechanism which changes distance between the touch sensor and the display panel.

The control system according to another exemplary aspect of the invention is a control system which controls the distance variable mechanism provided to the display device with the touch sensor of the present invention, and the control system includes: a signal input unit which receives a detection signal outputted from the touch sensor; a display monitor which displays the detection signal inputted to the signal input unit; a drive unit which supplies a driving force for changing the distance between the touch sensor and the display panel to the distance variable mechanism; a control unit which electrically controls the driving force that is supplied to the distance variable mechanism from the drive unit; and an indicator unit which displays a touch position on the display panel based on the detection signal inputted to the signal input unit.

The control method according to still another exemplary aspect of the invention uses the control system of the present invention, and the control method includes: adjusting the distance between the display panel and the touch sensor by operating the control unit in such a manner that an external noise contained in the detection signal displayed on the display monitor is reduced.

### BRIEF DESCRIPTION OF THE DRAWINGS

FIG. 1 is a plan view showing a display device with a touch sensor according to a first exemplary embodiment;

FIG. 2 is a sectional view taken along a line II-II of FIG. 1;

FIG. 3 is an enlarged sectional view of the touch sensor shown in FIG. 2;

FIGS. 4A and 4B show enlarged sectional views of a distance variable mechanism shown in FIG. 2, in which FIG. 4A is a case where the distance between the touch sensor and the display panel is increased and FIG. 4B is a case where the distance between the touch sensor and the display panel is decreased;

FIG. 5 is a functional block diagram showing a control system according to the first exemplary embodiment;

FIG. 6 is a plan view showing a part of the control system shown in FIG. 5;

FIG. 7 is a view of an external appearance showing the entire control system shown in FIG. 5;

FIG. 8 is a flowchart showing a control method according to the first exemplary embodiment;

FIG. 9 is a plan view showing the display panel in which touch positions for adjustment are shown in advance on a screen according to the control method shown in FIG. 8;

FIG. 10 is a graph showing a 3D waveform of the detection signal outputted from the touch sensor shown in FIG. 2, which is a case where a finger does not touch the touch sensor;

FIG. 11 is a graph showing a 3D waveform of the detection signal outputted from the touch sensor shown in FIG. 2, which is a case where a finger touches the touch sensor;

FIG. 12 is a graph showing a 3D waveform of the detection signal outputted from the touch sensor shown in FIG. 2, which is a case where the external noises are suppressed by the control system shown in FIG. 5;

FIG. 13 is a sectional view showing a display device with a touch sensor according to a second exemplary embodiment;

FIGS. 14A and 14B show enlarged sectional views of a distance variable mechanism shown in FIG. 13, in which FIG. 14A is a case where the distance between the touch sensor and the display panel is increased and FIG. 14B is a case where the distance between the touch sensor and the display panel is decreased;

FIG. 15 is a plan view showing a part of a control system according to the second exemplary embodiment;

FIG. 16 is a view of an external appearance showing the entire control system according to the second exemplary embodiment; and

FIGS. 17A and 17B show the technique depicted in Patent Document 1, in which FIG. 17A is a sectional view and FIG. 17B is a plan view.

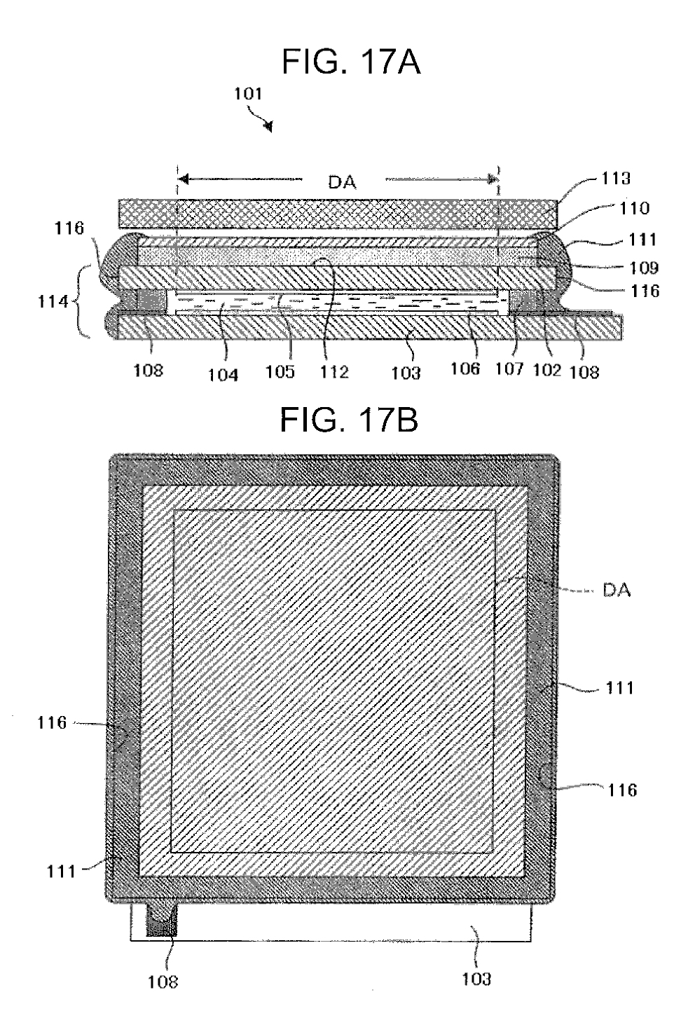

### DETAILED DESCRIPTION OF THE PREFERRED EMBODIMENTS

Hereinafter, modes for carrying out the present invention (referred to as “exemplary embodiments” hereinafter) will be described by referring to the accompanying drawings. In this Specification and the drawings, same reference numerals are used for substantially the same structural elements. The shapes in the drawings are illustrated to be easily comprehended by those skilled in the art, so that the dimensions and ratios thereof do not necessarily correspond to actual ones.

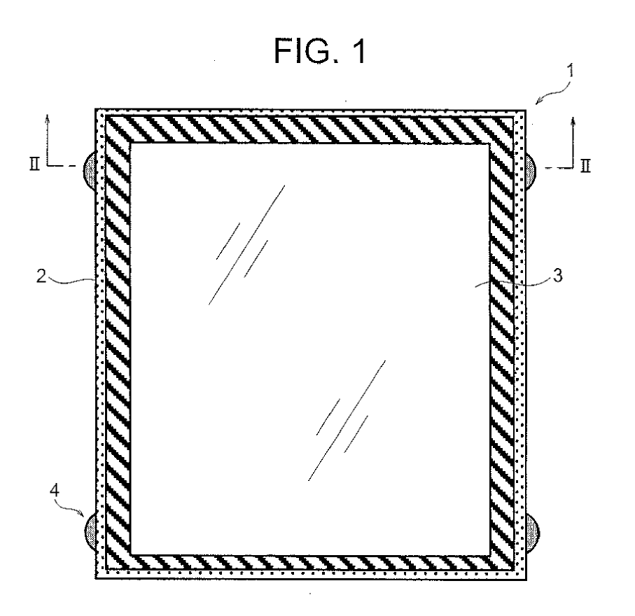

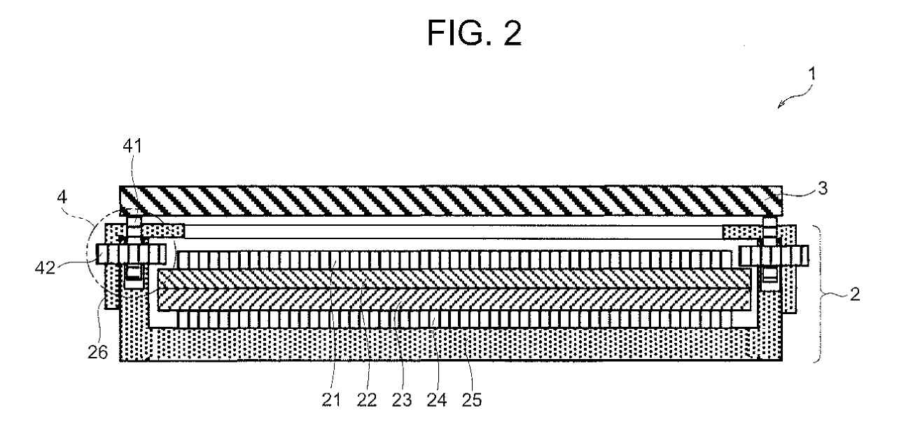

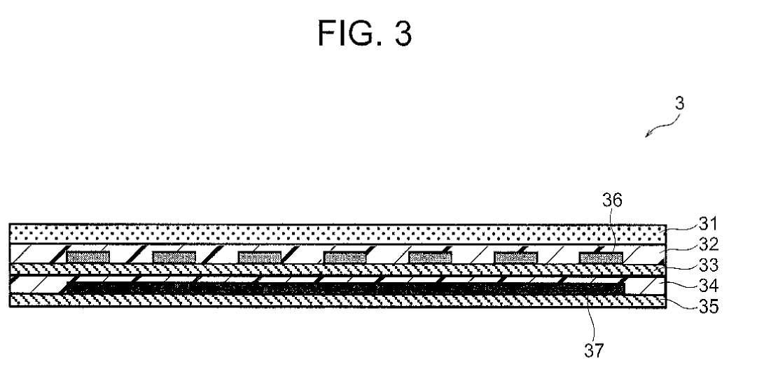

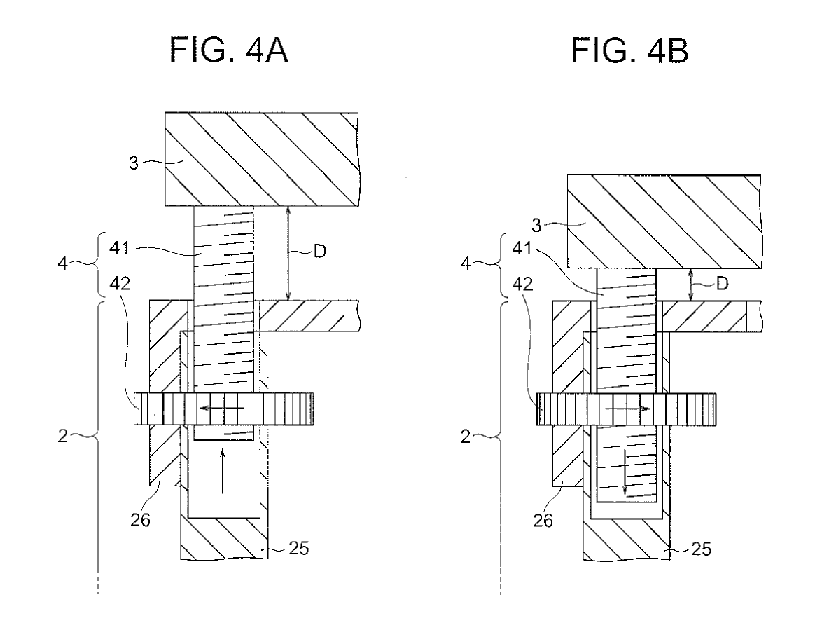

FIG. 1 is a plan view showing a display device with a touch sensor according to a first exemplary embodiment. FIG. 2 is a sectional view taken along a line II-II of FIG. 1. FIG. 3 is an enlarged sectional view of the touch sensor shown in FIG. 2. FIGS. 4A and 4B show enlarged sectional views of a distance variable mechanism shown in FIG. 2, in which FIG. 4A is a case where the distance between the touch sensor and the display panel is increased and FIG. 4B is a case where the distance between the touch sensor and the display panel is decreased. Hereinafter, explanations will be provided by referring to those drawings.

A display device 1 with a touch sensor according to the first exemplary embodiment includes: a display panel 2; a capacitance type touch sensor 3 provided by being superimposed on the display panel 2; and a distance variable mechanism 4 which changes the distance between the touch sensor 3 and the display panel 2.

The distance variable mechanism 4 is provided at a plurality of points between the touch sensor 3 and the display panel 2. In the first exemplary embodiment, the touch sensor 3 and the display panel 2 are in a square shape. Thus, the distance variable mechanism 4 is provided at each of the four corners of the rectangle, i.e., at the four points.

The distance variable mechanism 4 includes: a bolt 41 provided on the touch sensor 3 side; and a nut 42 which is provided on the display panel 2 side and fitted to the bolt 41. When the nut 42 is rotated, the distance D between the touch sensor 3 and the display panel 2 is changed. It is also possible to provide the bolt 41 on the display panel 2 side and provide the nut 42 on the touch sensor 3 side, and also possible to employ the structure with which the distance D between the touch sensor 3 and the display panel 2 is changed when the bolt 41 is rotated.

The display device 1 with the touch sensor according to the first exemplary embodiment will be described in more details.

As shown in FIG. 1 and FIG. 2, the touch sensor 3 is provided on the display panel 2, and it is supported to the display panel 2 via a plurality of the distance variable mechanisms 4. The display panel 2 is a liquid crystal panel, for example. The touch sensor 3 is of a capacitance type which detects a contact of a finger and a pen (object) according to a change in the capacitance.

As shown in FIG. 2, the display panel 2 includes a laminated body of substrates 21 to 24, a casing 25 for housing the substrates 21 to 24, a frame part 26 provided on the fringe of the casing 25, and the like. The substrates 21 to 24 are components constituting the liquid crystal panel, and examples of those are TFT substrates, color filter substrates, polarization plates, printed boards, and the like.

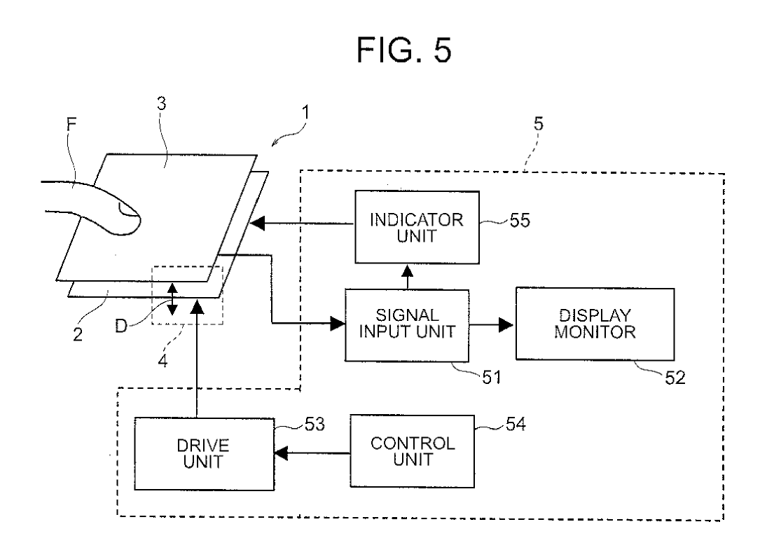

As shown in FIG. 3, the touch sensor 3 is a laminated body constituted with a front cover 31, adhesives 32, 34, substrates 33, 35, a transparent electrode (Y direction) 36, a transparent electrode (X direction) 37, and the like, and it employs a structure in which a great number of transparent electrodes 36, 37 are placed on the substrates 33, 35 constituted with one layer or more of glass or PET (polyethylene terephthalate). The transparent electrodes 36 and the transparent electrodes 37 are placed to oppose to each other, and are electrically connected to a control system 5 (FIG. 5), respectively, via wirings that are not shown.

As shown in FIG. 4, the plurality of distance variable mechanisms 4 for adjusting the distance D between the touch sensor 3 and the display panel 2 are provided between the touch sensor 3 and the display panel 2. The distance variable mechanism 4 is a screw feed mechanism which includes the bold 41 as the prop for supporting the touch sensor 3 and the nut 42 as a vertical feed module for moving up and down the bolt 41. The bolt 41 is fixed to the touch sensor 3, and the nut 42 is rotatably fixed to the display panel 2. Therefore, when the nut 42 is rotated, the bolt 41 and the touch sensor 3 are shifted vertically with respect to the display panel 2. Thus, the distance D between the touch sensor 3 and the display panel 2 is changed. Note that the circumference of the nut 42 is in a gear form, for example.

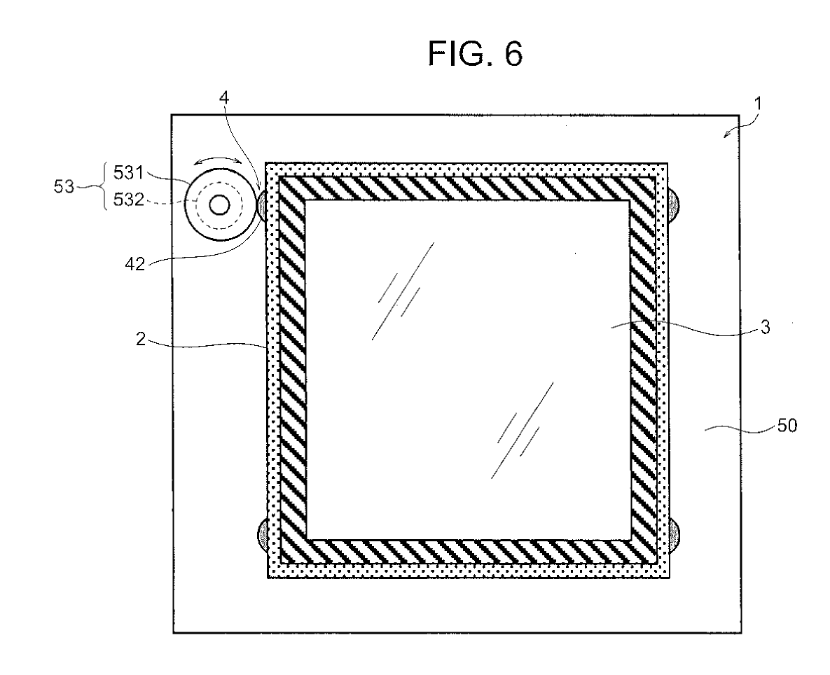

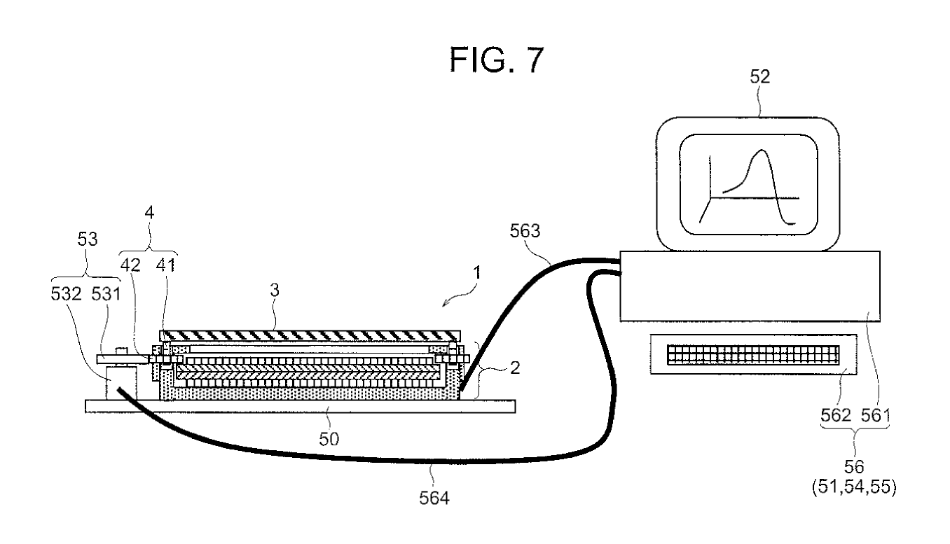

FIG. 5 is a functional block diagram showing a control system according to the first exemplary embodiment. FIG. 6 is a plan view showing a part of the control system shown in FIG. 5. FIG. 7 is a view of an external appearance showing the entire control system shown in FIG. 5. Hereinafter, explanations will be provided by referring to those drawings.

As shown in FIG. 5, the control system 5 according to the first exemplary embodiment is a control system which controls the distance variable mechanisms 4 provided to the display device 1 with the touch sensor. The control system 5 includes: a signal input unit 51 which receives a detection signal outputted from the touch sensor 3; a display monitor 52 which displays the detection signal inputted to the signal input unit 51; a drive unit 53 which supplies a driving force for changing the distance D between the touch sensor 3 and the display panel 2 to the distance variable mechanisms 4; a control unit 54 which electrically controls the driving force supplied to the distance variable mechanisms 4 from the drive unit 53; and an indicator unit 55 which displays, on the display panel 2, a touch position based on the detection signal inputted to the signal input unit 51.

In other words, the control system 5 includes: the signal input unit 51 which processes the detection signal outputted from the touch sensor 3; the display monitor 52 which display the information acquired by the signal input unit 51; the indicator unit 55 which indicates the touch position on the display panel 2; the drive unit 53 which drives the distance variable mechanisms 4; and the control unit 54 which controls the drive unit 53.

As shown in FIG. 6 and FIG. 7, the drive unit 53 includes a gear 531 fitted with the circumference of the nut 42, and a motor 532 which rotates the gear 531. The drive unit 53 is fixed to a base 50, and the display device 1 with the touch sensor is detachably fixed to the base 50. The signal input unit 51, the control unit 54, and the indicator unit 55 are implemented in a personal computer 56, for example, by software. The personal computer 56 includes a main body 561, a keyboard 562, and the like. The main body 561 is electrically connected to the display device 1 with the touch sensor via a wiring 563, and electrically connected to the motor 532 via a wiring 564. The teeth of the gear 531 are not illustrated in the drawings.

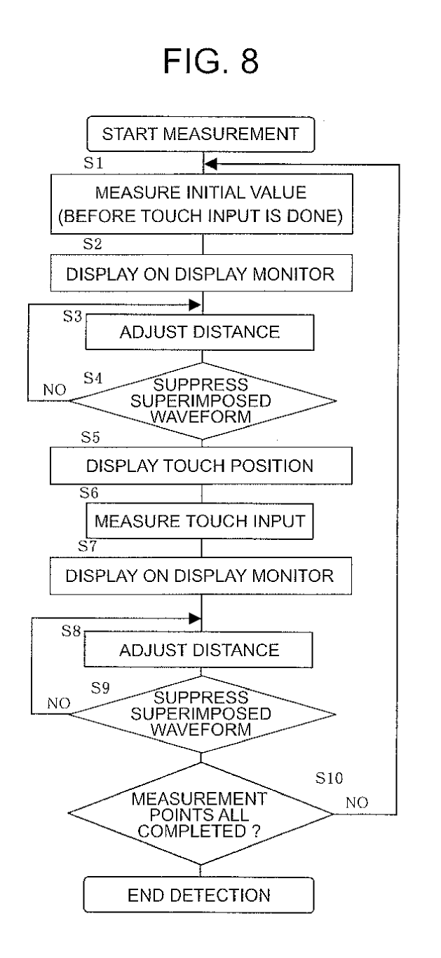

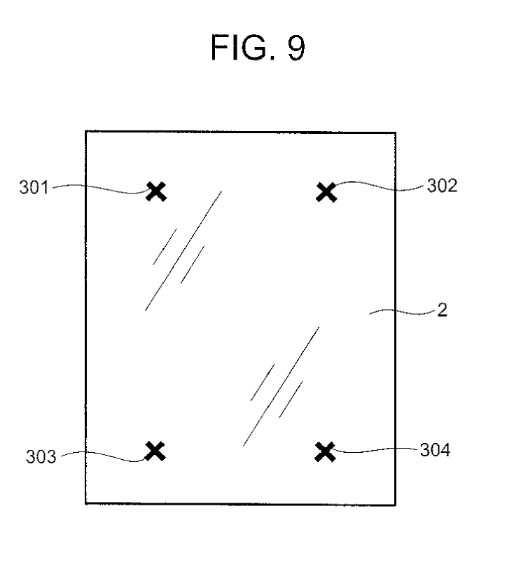

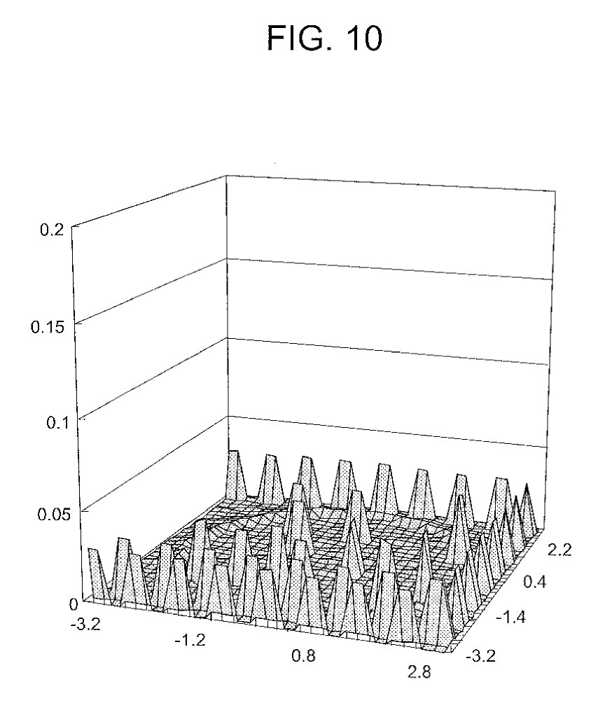

FIG. 8 is a flowchart showing a control method according to the first exemplary embodiment. FIG. 9 is a plan view showing the display panel in which the touch positions for adjustment are shown in advance on the screen. FIG. 10 to FIG. 12 are graphs which show the detection signals (electric signals) outputted from the touch sensor in 3D waveforms. Hereinafter, the control method according to the first exemplary embodiment will be described by referring to FIG. 5 and FIG. 8 to FIG. 12.

The outline of the control method according to the first exemplary embodiment will be described by mainly referring to FIG. 5. The control method according to the first exemplary embodiment uses the control system 5 of the first exemplary embodiment, and adjusts the distance D between the display panel 2 and the touch panel 3 through operating the control unit 54 so that the external noise contained in the detection signal displayed on the display monitor 52 is reduced.

At that time, the control unit 54 may be operated in such a manner that the external noise becomes the minimum. Further, the control unit 54 may be operated in such a manner that a parallax between the touch position detected by the touch sensor 3 and the touch position displayed on the display panel 2 by the indicator 55 falls within an allowable range and that the external noise becomes the minimum.

The details of the control method according to the first exemplary embodiment will be described by mainly referring to FIG. 5 and FIG. 8.

FIG. 8 (step S1): The signal input unit 51 acquires the detection signal outputted from the touch sensor 3 in a state where a finger F is not touching the touch sensor 3.

FIG. 8 (step S2): The display monitor 52 displays the acquired data on the screen. As shown in FIG. 10, the acquired data are random noises. At this time, the finger F is not touching the touch sensor 3, so that the displayed values are external noises arrived at the touch sensor 3 from outside. In FIG. 10 to FIG. 12, the X-axis and the Y-axis show the position coordinates, and the Z-axis shows the signal intensities.

FIG. 8 (step S3): The operator drives the drive unit 53 by operating the control unit 54 via an input device such as the keyboard 562 while observing the values displayed on the display monitor 52 to move up and down the bolts 41 (FIG. 4) of the distance variable mechanisms 4 and the touch sensor 3.

FIG. 8 (step S4): The operator adjusts the distance variable mechanisms 4 in such a manner that the value displayed on the display monitor 52 becomes an intended value (the minimum value). When completing the adjustment, the operator advances to the next step S5.

FIG. 8 (step S5): As shown in FIG. 9, the indicator unit 55 displays in advance the position where the finger F touches thereafter, i.e., the touch positions 301 to 304 on the touch sensor 3, on the display panel 2. The touch positions 301 to 304 are four points corresponding to the four corners of the touch sensor 3.

FIG. 8 (step S6): The operator touches one of the touch positions 301 to 304 displayed on the display panel 2 by the finger F. Upon that, the signal input unit 51 acquires the detection signal outputted from the touch sensor 3.

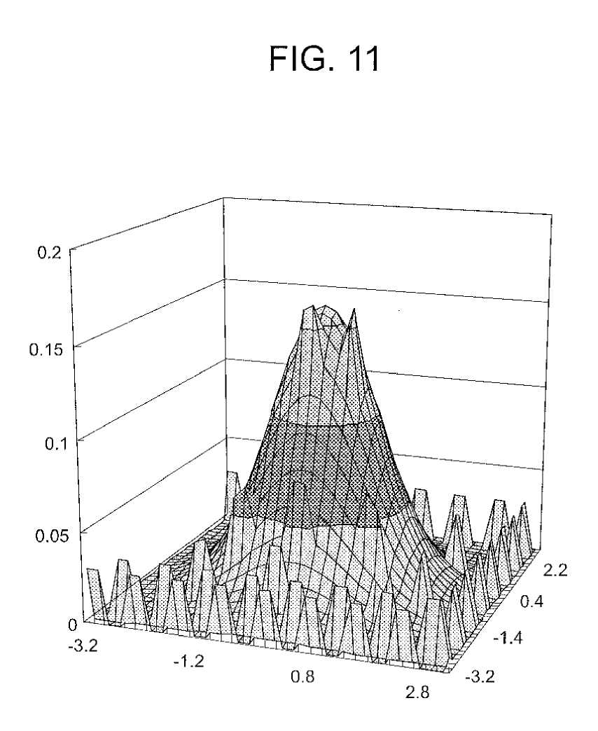

FIG. 8 (step S7): The display monitor 52 displays the data acquired by the signal input unit 51 on the screen. As shown in FIG. 11, the acquired data is in a state where the external noise is mixed into the true detection signal. That is, while the values displayed in step S2 contain the external noises, the values shown in step S7 contain both the values when the touch sensor 3 is touched by the finger F and the values of the external noises.

FIG. 8 (step S8): The operator drives the drive unit 53 through operating the control unit 54 while observing the values displayed on the display monitor 52 to move up and down the bolts 41 (FIG. 4) of the distance variable mechanisms 4 and the touch sensor 3.

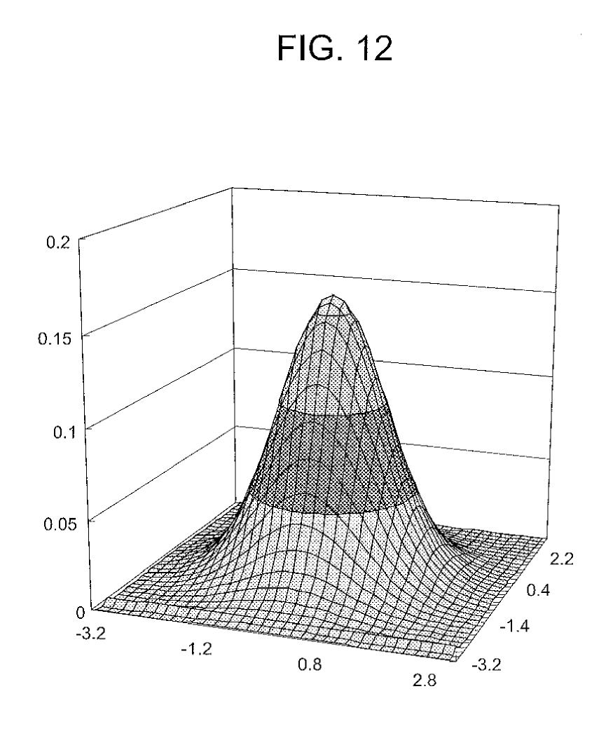

FIG. 8 (step S9): The operator adjusts the distance variable mechanisms 4 in such a manner that the value of the external noise displayed on the display monitor 52 becomes an intended value (the minimum value). When completing the adjustment, the operator advances to the next step S10. As shown in FIG. 12, the display screen after being adjusted shows only the true signal from which the external noise is eliminated.

FIG. 8 (step S10): The operator checks whether or not the adjustment is completed for all the touch positions 301 to 304 displayed on the display panel 2.

As described above, with the first exemplary embodiment, it is possible to adjust the external noise to be in an intended value by moving the distance variable mechanisms 4 while observing the data from the touch sensor 3 on the display monitor 52. Note that the intended value in the first exemplary embodiment is the value with which the external noise displayed on the display monitor 52 becomes the minimum.

Further, there is a case where a parallax is generated between the touch position detected by the touch sensor 3 and the touch position displayed on the display panel 2 by the indicator unit 55 because the distance D between the touch sensor 3 and the display panel 2 becomes too distant through moving the distance variable mechanisms 4. In such case, the distance variable mechanisms 4 are adjusted in such a manner that the external noise becomes the minimum within a range of the distance D with which the parallax can be tolerated.

While the distance variable mechanism 4 is provided, respectively, at the four corners of the touch sensor 3 for the sake of explanations, it is possible to provide a larger or smaller number of the distance variable mechanisms 4 depending on the screen size or the like. In a case where a plurality of distance adjustment points are provided, the accuracy of position detection can be improved further.

The effects of the first exemplary embodiment are as follows. Through adjusting the distance D between the touch sensor 3 and the display panel 2, the noise superimposed on the output signal from the touch sensor 3 can be suppressed. Further, it is possible to adjust the distance D between the touch sensor 3 and the display panel 2 in such a manner that the noise can be in an intended value, while detecting the noise superimposed on the output signal from the touch sensor 3. Furthermore, it is also possible to increase the detection accuracy of the touch position even in a state where the touch sensor 3 is being combined with the display panel 2 or in a state where the display device 1 with the touch sensor is being mounted into the electronic apparatus. Moreover, since the distance is adjusted in a state where the touch sensor 3 is being placed on the display panel 2 or in a state where the display device 1 with touch sensor is being mounted into the electronic apparatus, it is possible to increase the detection accuracy of the touch position regardless of the affinity of each member that varies for each device. Examples of the electronic apparatus to which the display device 1 with the touch sensor is mounted may be a mobile phone, an information mobile terminal, and the like.

As an exemplary advantage according to the invention, it is possible to suppress the noise superimposed on the detection signal of the touch sensor by adjusting the distance between the touch sensor and the display panel. Further, it is also possible to adjust the distance between the touch sensor and the display panel to control the noise to be in an intended value while detecting the noise superimposed on the detection signal of the touch sensor. Furthermore, it is possible to increase the detection accuracy of the touch position even in a state where the touch sensor is being combined with the display panel or in a state where the display device with the touch sensor is being mounted into the electronic apparatus. Moreover, since the distance is adjusted in a state where the touch sensor is being placed on the display panel or in a state where the display device with the touch sensor is being mounted into the electronic apparatus, it is possible to increase the detection accuracy of the touch position regardless of the affinity of each member that varies for each device.

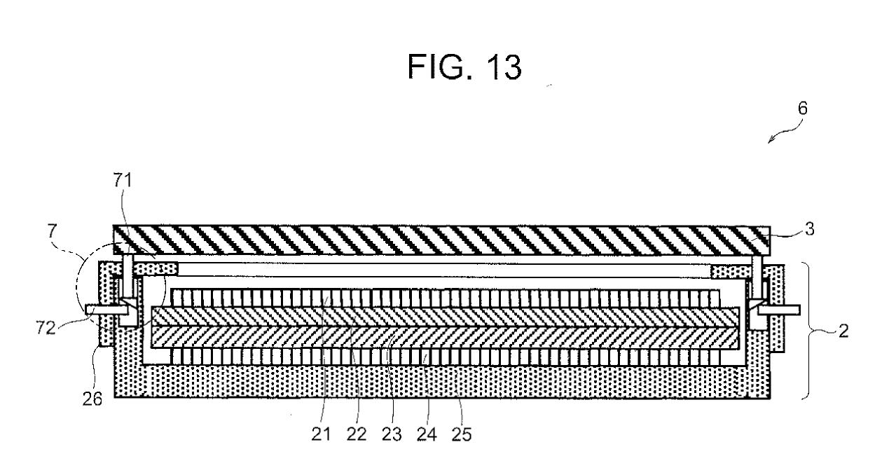

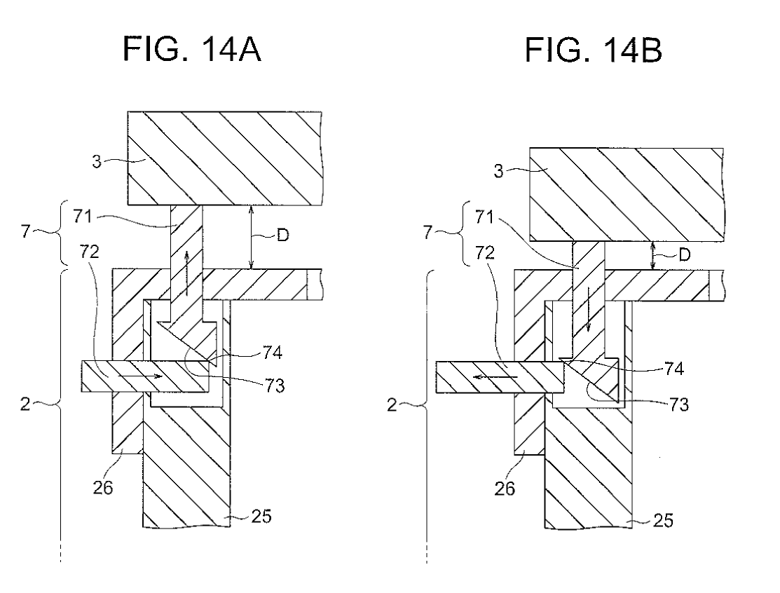

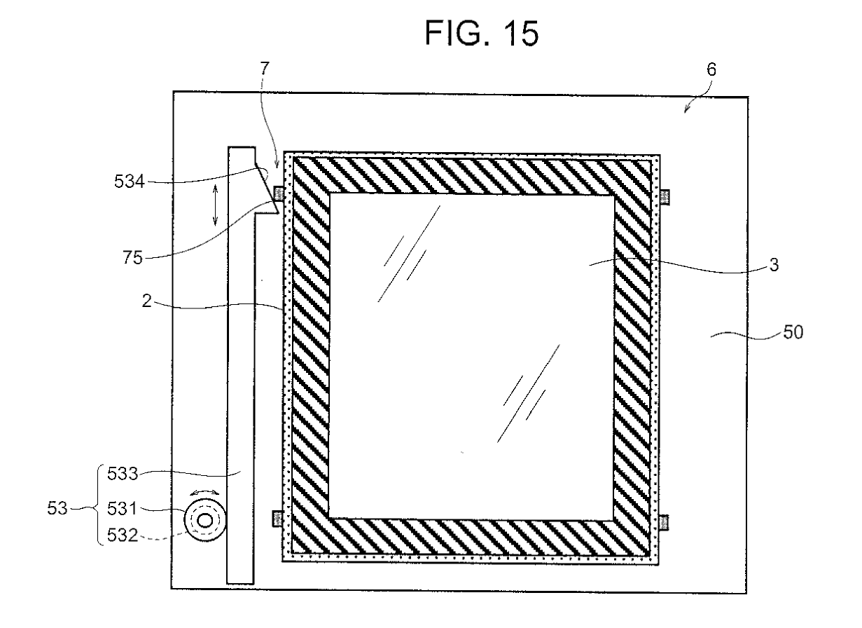

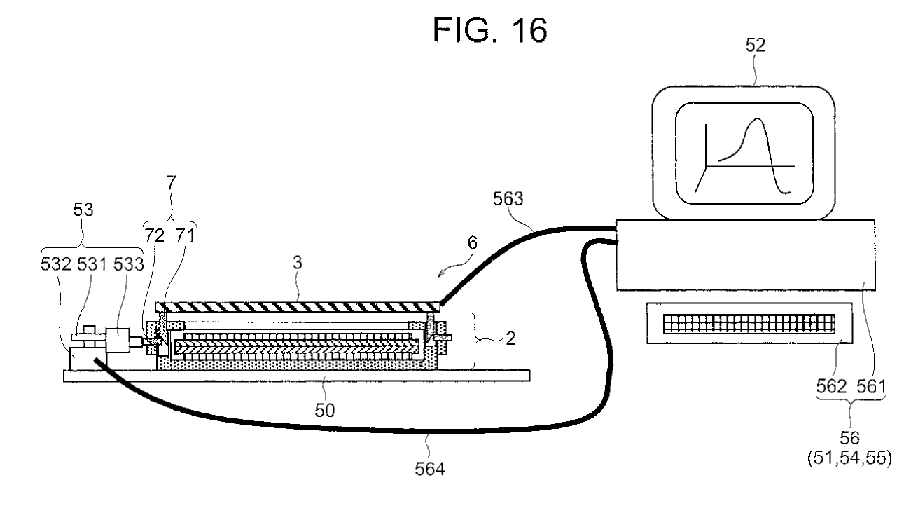

FIG. 13 is a sectional view showing a display device with a touch sensor according to a second exemplary embodiment. FIGS. 14A and 14B show enlarged sectional views of a distance variable mechanism shown in FIG. 13, in which FIG. 14A is a case where the distance between the touch sensor and the display panel is increased and FIG. 14B is a case where the distance between the touch sensor and the display panel is decreased. FIG. 15 is a plan view showing a part of the control system according to the second exemplary embodiment. FIG. 16 is a view of an external appearance showing the entire control system according to the second exemplary embodiment. Hereinafter, the second exemplary embodiment will be described by referring to those drawings.

As shown in FIG. 13, a display device 6 with a touch sensor according to the second exemplary embodiment is different from that of the first exemplary embodiment in terms of the structure of a distance variable mechanism 7. The distance variable mechanism 7 includes: a prop 71 provided on the touch sensor 3 side; and an adjustment piece 72 which is provided on the display panel 2 side and engaged with the prop 71. The distance D between the touch sensor 3 and the display panel 2 is changed when the adjustment piece 72 is pushed or pulled. In other words, as the means for vertically moving the prop 71, the distance variable mechanism 7 employs not the screw-in module of the bolt and the nut but an engaged module with which the prop 71 is slid and moved vertically when the adjustment piece 72 is pushed or pulled.

As shown in FIG. 14, the tip end of the prop 71 forms a slope 73, and the tip end of the adjustment piece 72 forms a protrusion 74. When there is a contact between the slope 73 and the protrusion 74, the direction of the force applied to the adjustment piece 72 and the direction of the force applied to the prop 71 become different by 90 degrees. That is, when the adjustment piece 72 moves in the horizontal direction, the prop 71 moves in the vertical direction. The prop 71 and the adjustment price 72 are fitted into the frame part 26 of the display panel 2 with a specific pressure. Thus, when a strong force of more than the specific pressure is applied thereto, those are slid and moved with respect to the frame part 26. When the force is lifted, those are fixed at that position.

As shown in FIG. 15 and FIG. 16, a pressing piece 533 is added to the drive unit 53 by conforming to the structure of the distance variable mechanism 7. The side face of the pressing piece 533 and the gear 531 attached to the rotary shaft of the motor 532 are in a rack-and-pinion structure, for example, and the rotational motion of the motor 532 is transformed to the linear motion of the pressing piece 533. A slope 534 is provided on the other side face of the pressing piece 533, and the slope 534 and a protrusion 75 on the base side of the adjustment piece 72 are to come in contact with each other. For example, in a state were the adjustment piece 72 is pulled out to the maximum, the adjustment piece 72 is pushed in by the pressing piece 533 gradually so that the adjustment piece 72 is fixed at the optimum position.

With the second exemplary embodiment, it is possible to improve the position accuracy with high convenience since the structure of the distance variable mechanism 7 is simpler than that of the first exemplary embodiment. Other structures, operations, and effects of the second exemplary embodiment are the same as those of the first exemplary embodiment.

While the present invention has been described above by referring to each of the exemplary embodiments, the present invention is not limited only to each of the exemplary embodiments described above. Regarding the structures and details of the present invention, various changes and modifications occurred to those skilled in the art can be applied. For example, it is possible to adjust the distance variable mechanism by human power instead of using the drive unit or to use an organic EL panel or the like as the display panel. Further, the present invention includes the structures acquired by mutually and properly combining a part of or a whole part of the structures of each of the above-described exemplary embodiments.

While a part of or a whole part of the exemplary embodiments described above can be summarized as follows, the present invention is not limited only to the following structures.

(Supplementary Note 1)

A display device with a touch sensor, which includes:
a display panel;
a capacitance type touch sensor which is provided by being superimposed on the display panel; and
a distance variable mechanism which changes distance between the touch sensor and the display panel.

(Supplementary Note 2)

The display device with the touch sensor as depicted in Supplementary Note 1, wherein
the distance variable mechanism is provided, respectively, at a plurality of points between the touch sensor and the display panel.

(Supplementary Note 3)

The display device with the touch sensor as depicted in Supplementary Note 1 or 2, wherein:
the distance variable mechanism includes a bolt which is provided to either one out of the touch sensor and the display panel, and a nut which is provided to the other one out of the touch sensor and the display panel by being fitted into the bolt; and the distance between the touch sensor and the display panel is changed when either the bolt or the nut is rotated.

(Supplementary Note 4)

The display device with the touch sensor as depicted in Supplementary Note 1 or 2, wherein:
the distance variable mechanism includes a prop which is provided on the touch sensor side, and an adjustment piece which is provided on the display panel side and engaged with the prop; and the distance between the touch sensor and the display panel is changed when the adjustment piece is pushed or pulled.

(Supplementary Note 5)

A control system which controls the distance variable mechanism provided to the display device with the touch sensor as depicted in any one of Supplementary Notes 1 to 4, and the control system includes:
a signal input unit which receives a detection signal outputted from the touch sensor;
a display monitor which displays the detection signal inputted to the signal input unit;
a drive unit which supplies a driving force for changing the distance between the touch sensor and the display panel to the distance variable mechanism;
a control unit which electrically controls the driving force that is supplied to the distance variable mechanism from the drive unit; and
an indicator unit which displays a touch position on the display panel based on the detection signal inputted to the signal input unit.

(Supplementary Note 6)

A control method using a control system which controls a distance variable mechanism provided to a display device with a touch sensor, the display device including:
a display panel;
a capacitance type touch sensor which is provided by being superimposed on the display panel; and
the distance variable mechanism which changes distance between the touch sensor and the display panel, wherein the control system includes:
a signal input unit which receives a detection signal outputted from the touch sensor;
a display monitor which displays the detection signal inputted to the signal input unit;
a drive unit which supplies a driving force for changing the distance between the touch sensor and the display panel to the distance variable mechanism;
a control unit which electrically controls the driving force that is supplied to the distance variable mechanism from the drive unit; and
an indicator unit which displays a touch position on the display panel based on the detection signal inputted to the signal input unit, the control method comprising:
adjusting the distance between the display panel and the touch sensor by operating the control unit in such a manner that an external noise contained in the detection signal displayed on the display monitor is reduced.

(Supplementary Note 7)

The control method as depicted in Supplementary Note 6, wherein
the control unit is operated in such a manner that the external noise becomes minimum.

(Supplementary Note 8)

The control method as depicted in Supplementary Note 7, wherein
the control unit is operated in such a manner that a parallax between a touch position detected by the touch sensor and a touch position displayed on the display panel by the indicator unit falls within an allowable range and that the external noise becomes minimum.

(Supplementary Note 11)

A display device with a touch sensor including a display panel and a capacitance type touch sensor formed by being superimposed on the display panel, wherein
the display device includes a distance adjusting mechanism for adjusting the distance between the touch sensor and the display panel.

(Supplementary Note 12)

The display device with the touch sensor as depicted in Supplementary Note 11, wherein
the distance adjusting mechanism is placed at a plurality of points.

(Supplementary Note 13)

A control system which includes a display device, a capacitance type touch sensor formed by being superimposed on the display device, a distance adjusting mechanism which adjusts the distance between the display device and the touch sensor, and a controller which controls the distance adjusting mechanism, wherein
the controller includes: a processing device which processes an output signal from the touch sensor; a display monitor which displays information acquired by the processing device; a driving module which drives the distance adjusting mechanism; a control module which controls the driving module; and an indicator module which displays a pointer showing a touch position on the display device.

(Supplementary Note 14)

The control system as depicted in Supplementary Note 13, wherein
the distance between the display device and the touch sensor is adjusted in such a manner that the superimposed external noise becomes an intended value, while observing the value outputted from the touch sensor displayed on the display monitor.

(Supplementary Note 15)

The control system as depicted in Supplementary Note 14, wherein
the intended value is a value with which the external noise becomes minimum.

(Supplementary Note 16)

The control system as depicted in Supplementary Note 15, wherein
the intended value is a value with which, when there is a parallax generated between the touch position on the touch sensor and the touch position displayed on the display device since the distance between the touch sensor and the display panel becomes too distant, the external noise becomes minimum within a range where the parallax is tolerated.

What is claimed is:

1. A display device with a touch sensor, comprising:
a display panel;
a capacitance type touch sensor which is provided by being superimposed on the display panel; and
a distance variable mechanism which changes distance between the touch sensor and the display panel.

2. The display device with the touch sensor as claimed in claim 1, wherein
the distance variable mechanism is provided, respectively, at a plurality of points between the touch sensor and the display panel.

3. The display device with the touch sensor as claimed in claim 1, wherein:
the distance variable mechanism includes a bolt which is provided to either one out of the touch sensor and the display panel, and a nut which is provided to the other one out of the touch sensor and the display panel by being fitted into the bolt; and the distance between the touch sensor and the display panel is changed when either the bolt or the nut is rotated.

4. The display device with the touch sensor as claimed in claim 1, wherein:
the distance variable mechanism includes a prop which is provided on the touch sensor side, and an adjustment piece which is provided on the display panel side and engaged with the prop; and the distance between the touch sensor and the display panel is changed when the adjustment piece is pushed or pulled.

5. A control system which controls the distance variable mechanism provided to the display device with the touch sensor as claimed in claim 1, the control system comprising:
a signal input unit which receives a detection signal outputted from the touch sensor;
a display monitor which displays the detection signal inputted to the signal input unit;
a drive unit which supplies a driving force for changing the distance between the touch sensor and the display panel to the distance variable mechanism;
a control unit which electrically controls the driving force that is supplied to the distance variable mechanism from the drive unit; and
an indicator unit which displays a touch position on the display panel based on the detection signal inputted to the signal input unit.

6. A control method using a control system which controls a distance variable mechanism provided to a display device with a touch sensor, the display device including:
a display panel;
a capacitance type touch sensor which is provided by being superimposed on the display panel; and
the distance variable mechanism which changes distance between the touch sensor and the display panel, wherein the control system includes:
a signal input unit which receives a detection signal outputted from the touch sensor;
a display monitor which displays the detection signal inputted to the signal input unit;
a drive unit which supplies a driving force for changing the distance between the touch sensor and the display panel to the distance variable mechanism;
a control unit which electrically controls the driving force that is supplied to the distance variable mechanism from the drive unit; and
an indicator unit which displays a touch position on the display panel based on the detection signal inputted to the signal input unit, the control method comprising:
adjusting the distance between the display panel and the touch sensor by operating the control unit in such a manner that an external noise contained in the detection signal displayed on the display monitor is reduced.

7. The control method as claimed in claim 6, wherein
the control unit is operated in such a manner that the external noise becomes minimum.

8. The control method as claimed in claim 7, wherein
the control unit is operated in such a manner that a parallax between a touch position detected by the touch sensor and a touch position displayed on the display panel by the indicator unit falls within an allowable range and that the external noise becomes minimum.
